(19) United States
(12) Patent Application Publication
(10) Pub. No.: US 2013/0188253 A1
(43) Pub. Date: Jul. 25, 2013

(54) SUBSTRATE WITH INTERFERENCE FILTER LAYER AND DISPLAY DEVICE USING THE SAME

(71) Applicants: Yutaka NAKAI, Yokohama-shi (JP); Tomio Ono, Yokohama-shi (JP); Yoshinori Honguh, Yokohama-shi (JP); Hideki Nukada, Yokohama-shi (JP); Yuzo Hirayama, Yokohama-shi (JP); Hitoshi Nagato, Kunitachi-shi (JP); Takashi Miyazaki, Kawasaki-shi (JP)

(72) Inventors: Yutaka NAKAI, Yokohama-shi (JP); Tomio Ono, Yokohama-shi (JP); Yoshinori Honguh, Yokohama-shi (JP); Hideki Nukada, Yokohama-shi (JP); Yuzo Hirayama, Yokohama-shi (JP); Hitoshi Nagato, Kunitachi-shi (JP); Takashi Miyazaki, Kawasaki-shi (JP)

(21) Appl. No.: 13/554,339

(22) Filed: Jul. 20, 2012

Related U.S. Application Data
(63) Continuation of application No. PCT/JP2010/000334, filed on Jan. 21, 2010.

(51) Int. Cl. G02B 5/28

(52) U.S. Cl. CPC G02B 5/28
USPC 359/584

(57) ABSTRACT

According to one embodiment, a substrate with an interference filter layer includes a plate-like first substrate and a filter layer. The filter layer includes optically semi-transparent first and second reflective layers and a light-transmitting layer, the light-transmitting layer being formed of first, second, and third spacer layers, the first, second, and third spacer layers being optically transparent, the light-transmitting layer including first, second, and third areas which include the first spacer layer in common, the first, second, and third areas having different optical film thicknesses due to the second and the third spacer layers, the first, second, and the third areas transmitting light with different wavelengths.

### CROSS-REFERENCE TO RELATED APPLICATIONS

This application is a Continuation Application of PCT Application No. PCT/JP2010/000334, filed Jan. 21, 2010, the entire contents of which are incorporated herein by reference.

### FIELD

Embodiments described herein relate generally to a substrate with an interference filter layer and a display device using the substrate with the interference filter layer.

### BACKGROUND

With the start of terrestrial digital broadcasting and the spread of the Internet and cellular phones, there have been growing demands for display devices including liquid crystal displays and plasma displays. Some of these displays are mounted in mobile devices as small displays, whereas demands for large-screen televisions have been increasing.

In the conventional displays, matrix lines are provided on a glass substrate. In particular, in liquid crystal displays, thin-film transistors are provided at intersections between the matrix lines. At a very short distance from this array substrate, a counter substrate is arranged. Liquid crystal is injected into the gap between the array substrate and the counter substrate. A liquid crystal display device is thus configured.

In color display provided by the liquid display device, colors are controlled by emission of red light, green light, and blue light from a color filter; the color filter is arranged on the counter substrate to allow corresponding light to pass through. The color filter used is of an absorption type using pigment or dye. Thus, if white light emitted from a backlight installed on a rear surface of the liquid crystal display device and entering the liquid crystal display device passes through, for example, a blue filter, the blue filter absorbs green light and red light, resulting in a loss. This also applies to a green filter and a red filter. Thus, the light use efficiency of the color filter eventually decreases to one-third.

To solve this problem, a scheme using an interference filter has been proposed as disclosed in JP-A 8-508114 (KOHYO). According to this scheme, interference filters are provided in association with the respective colors of pixels to selectively allow red light, green light, or blue light to pass through, while feeding light having failed to pass though the interference filters back to the backlight. In this manner, the light is reused.

However, such a display device as described above requires the formation, for each pixel, of a color filter layer through which red, green, or blue light is transmitted. Thus, disadvantageously, the display device involves a very complicated manufacturing process. If the interference filter is formed by stacking a large number of thin films, a step of accurately stacking a large number of thin films and a step of separating the stacked multilayer films into portions corresponding to the pixels both need to be repeated three times in order to form red, green, and blue filters. JP-A 8-508114 (KOHYO) attempts to reduce the number of steps by using a lift-off process. However, in the lift-off process, films stripped in conjunction with removal of resist may re-adhere to a substrate, leading to reduced yield. Thus, newly introducing the lift-off process into the liquid crystal display manufacturing process may be difficult.

### BRIEF DESCRIPTION OF THE DRAWINGS

FIG. 1 is a cross-sectional view showing the configuration of a substrate with an interference filter layer according to one embodiment;

FIG. 2 is a diagram showing the optical characteristics of a substrate with a interference filter layer according to the embodiment;

FIG. 3 is a cross-sectional view showing the configuration of a display device according to one embodiment;

FIG. 4 is a diagram showing the optical characteristics of a color filter;

FIG. 5 is a diagram showing the relationship between the characteristics and efficiency of a substrate with a interference filter layer according to one embodiment;

FIG. 6 is a diagram showing the optical characteristics of a substrate with a interference filter layer according to a comparative example;

FIGS. 7A, 7B, and 7C are diagrams showing a sequence of steps of manufacturing the substrate with the interference filter layer shown in FIG. 1;

FIG. 8A is a plan view showing the structure of an alignment mark for the substrate with the interference filter layer according to one embodiment;

FIG. 8B is a cross-sectional view showing the structure of the alignment mark shown in FIG. 8A;

FIGS. 9A, 9B, and 9C are diagrams showing a sequence of steps of manufacturing an interference filter layer according to one embodiment;

FIG. 10 is a diagram showing the configuration of a substrate with an interference filter layer according to another embodiment;

FIG. 11 is a diagram showing the configuration of a display device according to another embodiment; and

FIG. 12 is a diagram showing the configuration of a substrate with an interference filter layer according to further embodiment.

### DETAILED DESCRIPTION

In general, according to one embodiment, a substrate with an interference filter layer includes a plate-like first substrate and a filter layer. The filter layer includes a first reflective layer provided on the first substrate, a light-transmitting layer provided on the first reflective layer, and a second reflective layer provided on the light-transmitting layer, the first reflective layer and the second reflective layer being optically semi-transparent, the light-transmitting layer being formed of a first spacer layer provided on the first reflective layer, a second spacer layer, and a third spacer layer, the second spacer layer and the third spacer layer being provided on or above parts of the first reflective layer, the first spacer layer, the second spacer layer, and the third spacer layer being optically transparent, the light-transmitting layer including a first area, a second area, and a third area which include the first spacer layer in common, the first area, the second area, and the third area having different optical film thicknesses due to the second spacer layer and the third spacer layer, the first area, the second area, and the third area transmitting light with different wavelengths.

Embodiments provide a substrate with an interference filer layer, which can be formed by a reduced number of steps and achieve high light use efficiency, and a display device using the substrate with the interference filer layer.

Embodiments will be described below in detail.

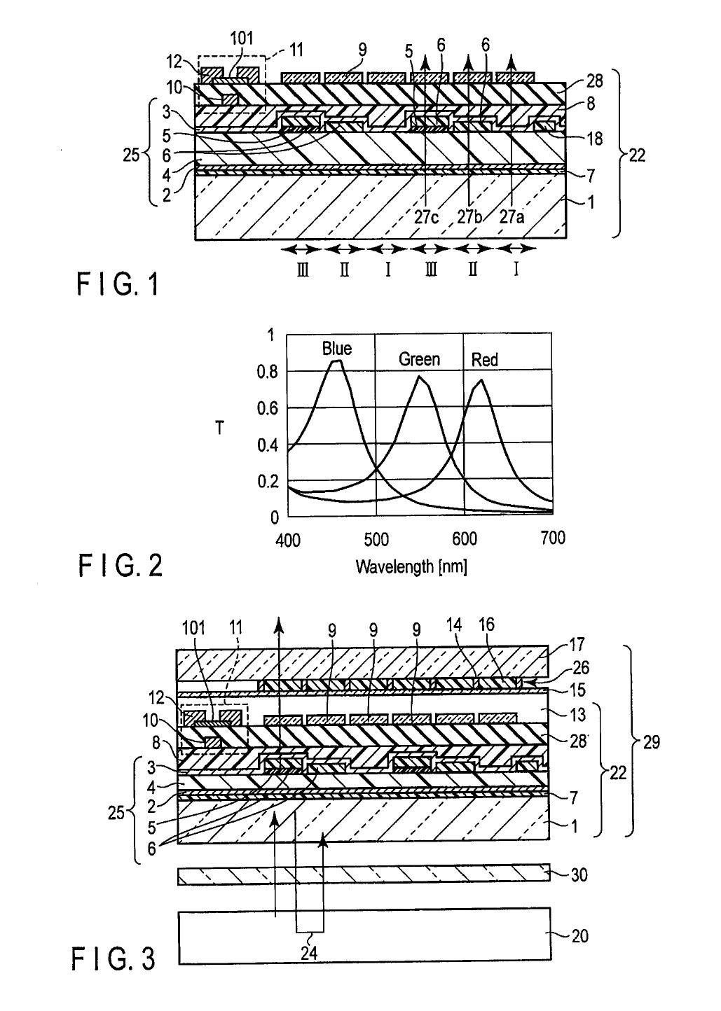

FIG. 1 is a cross-sectional view of a substrate 22 with a filter layer according to an embodiment as seen in a direction perpendicular to one principal surface of the substrate 22. FIG. 3 is a cross-sectional view of a liquid crystal display device that uses the substrate 22 with the filter layer as a part of a liquid crystal panel 29. The substrate 22 with the filter layer is an array substrate arranged opposite a counter substrate 17 via a liquid crystal layer 13 as shown in FIG. 3 and used in the display panel 29 of the liquid crystal display device. An absorptive color filter 26 is provided on the counter substrate 17. First, the substrate 22 with the filter layer will be described with reference to FIG. 1.

In the present embodiment, the substrate 22 with the filter layer in FIG. 1 adopts a Fabry-Perot interference filter as a filter layer 25.

Specifically, the filter layer 25 is formed of a first reflective layer 2, a first spacer layer 4, a second spacer layer 5, a third spacer layer 6, and a second reflective layer 3. The filter layer 25 includes three types of areas with different optical film thicknesses. The filter layer 25 is an interference filter having reflectance and transmittance made dependent on wavelength by using interference between two parallel planes (i.e., the first reflective layer 2 and the second reflective layer 3) which is caused by multiple optical reflections. That is, the filter layer 25 allows light with different wavelengths to pass through the respective three types of areas.

Specifically, as shown in FIG. 1, the substrate 22 with the filter layer includes a plate-like substrate 1, the filter layer 25 provided on a principal surface of the substrate 1, an overcoat layer 8 formed on the filter layer 25, a gate insulating film 28 provided on the overcoat layer 8, pixel electrodes 9 provided on the gate insulating film 28, and a thin-film transistor 11 provided on a part of the overcoat layer 8.

On the transparent glass substrate 1, an undercoat layer 7 is formed of a silicon dioxide film. The filter layer 25 is formed on the undercoat layer 7. That is, the first reflective layer 2, which is optically semi-transparent (or translucent) to light in a visible wavelength range and partially reflects the light, is formed on the undercoat layer 7. Moreover, a silicon dioxide film is formed, as the first spacer layer 4, on the first reflective layer 2. A silicon nitride film is selectively formed as the second spacer film 5.

The third spacer layer 6 is formed on the second spacer 5 and the first spacer layer 4. As the third spacer layer 6, a silicon nitride film is used similarly to the second spacer layer 5. In the same step as that for the second spacer layer 5, the third spacer layer 6 is selectively formed such that a part of the third layer 6 covers the second spacer layer 5. The third spacer layer 6 provided on the first spacer layer 4 is different from the second spacer layer 5 in optical film thickness.

The second reflective layer 3 is formed all over the surfaces of the third spacer layer 6, the second spacer layer 5, and the first spacer layer 4. The overcoat layer 8 is formed on the second reflective layer 3. The substrate 22 with the filter layer is configured as described above. The first spacer layer 4, the second spacer layer 5, and the third spacer layer 6 are collectively referred to as a light-transmitting layer.

Moreover, a gate line 10 is provided on the overcoat layer 8. The gate insulating film 28 is provided on the gate line 10 and the overcoat layer 8. The pixel electrodes 9, formed of a transparent conductive film, are provided on the gate insulating film 28. A semiconductor layer 101 and signal lines 12 are provided on the gate insulating film 28 at a position where the gate line 10 is provided; the signal lines 12 are provided at the opposite ends of the semiconductor layer 101. A part of each of the signal lines 12 covers the semiconductor layer 101. The gate line 10, the semiconductor layer 101, and the signal lines 12 form the thin-film transistor 11. Accordingly, portions of the filter layer 25 with different optical film thicknesses are provided under the respective adjacent pixel electrodes 9.

An alignment mark 18 is provided on a part of the first spacer layer 4 to align the filter layer 25 with the pixel electrodes 9, the thin-film transistor 11, and the like.

On a principal surface of the substrate 1 which lies opposite the principal surface on which the filter layer 25 is provided, a backlight (not shown) is provided opposite the glass substrate 1.

The filter layer 25 has a property to transmit light in a particular wavelength range and reflect light in the other wavelength ranges. The property is mainly defined by the optical film thickness obtained by multiplying refractive index by film thickness and by a phase shift of light reflected by the first reflective layer 2 or the second reflective layer 3.

The filter layer 25 has a configuration (or an optical film thickness group configuration) including a plurality of areas with different optical film thicknesses of the spacer layer. The first spacer layer 4 is provided to cover all of the plurality of areas of the filter layer 25, and the second spacer layer 5 and the third spacer layer 6 are provided in some of the areas. Thus, the filter layer 25 includes at least three types of areas (I, II, and III) with different optical film thicknesses. That is, the filter layer 25 includes an area (I) with the first spacer layer 4, an area (II) with the first spacer layer 4 and the third spacer layer 6, and an area (III) with the first spacer layer 4, the second spacer layer 5, and the third spacer layer 6. The three types of areas are different from one another in optical film thickness. When light is emitted from the principal surface of the substrate 1 on which the filter layer 25 is not provided, the three types of areas transmit light with different wavelengths and mainly reflect light with the wavelengths other than those for transmission.

For a light beam 27a passing through area I, a light beam 27b passing through area II, and a light beam 27c passing through area III, since the optical film thickness of the filter layer 25 varies among the respective optical paths, the transmission wavelength range and reflection wavelength range of the light beam in passing through the corresponding optical path varies among the optical paths. The filter layer 25 is designed such that light beams transmitted though the three types of optical paths 27a, 27b, and 27c corresponds to blue, green, and red, respectively. Thus, the filter layer 25 allows transmission of blue, green, and red light beams, which is suitable for displaying color image.

FIG. 2 is a diagram showing the relationship between the wavelength and transmittance T obtained when the above-described filter layer 25 is formed such that the three types of transmission light beams 27a, 27b, and 27c correspond to blue, green, and red. Silver (Ag) with a thickness of 25 nm is used as the first reflective layer 2 and the third reflective layer 3. A silicon dioxide film with a thickness of 100 nm is used as the first spacer film 4. A silicon nitride film with a thickness of 25 nm is used as the second spacer film 5. A silicon nitride film with a thickness of 15 nm is used as the third spacer film 6.

Red light beam is allowed to pass through the area in which the first spacer layer 4, the second spacer layer 5, and the third spacer layer 6 are provided (i.e., the area through which the transmission light beam 27c passes) and which thus has the greatest optical film thickness. Green light beam is allowed to pass through the area in which the first spacer layer 4 and the third spacer layer 6 are provided (i.e., the area through which the transmission light beam 27b passes) and which thus has the second greatest optical film thickness. Blue light beam is allowed to pass through the area in which the first spacer layer 4 is provided (i.e., the area through which the transmission light beam 27a passes) and which thus has the least optical film thickness.

The present embodiment uses two patterning steps to form the filter layer 25 with the three types of optical film thicknesses and thus requires substantially reduced costs. The manufacture according to the present embodiment is easy in that all the areas includes the first spacer layer 4 in common and in that an etching rate for the first spacer layer 4 is selected to be lower than those for the other spacer layers. Furthermore, when a reflective layer in a Fabry-Perot filter is made of metal, the filter allows the film thickness to be easily controlled, enabling a reduction in the number of steps required, compared to a conventional multilayer film filter designed such that each optical film thickness is equal to a quarter of the wavelength, and formed of a large number of films with different refractive indices stacked.

Almost all light having failed to pass through the filter layer 25 is reflected and fed back toward the backlight, where the light is reused. This mechanism will be described with reference to FIG. 3.

A liquid crystal display device shown in FIG. 3 includes a liquid crystal panel 29, a prismatic sheet 30, and a backlight unit 20.

The liquid crystal panel 29 includes an array substrate 22 (also called a first substrate) with the filter layer 25, a counter substrate 17 (also called a second substrate) arranged opposite the array substrate 22, and a liquid crystal layer 13 arranged between the array substrate 22 and the counter substrate 17. The array substrate 22 in FIG. 3 has the same configuration as that of the substrate 22 with the filter layer in FIG. 1. A color filter 26 and a counterelectrode 15 arranged on the color filter 26 are provided on the counter substrate 17. The color filter 26 includes three types of colored layers 16, which are periodically arranged, and black matrices 14 provided at the boundaries between the colored layers.

The three types of colored layers 16 transmit light with wavelengths substantially equivalent to those of light transmitted through the corresponding portions of the filter layer 25, while absorbing light with the other wavelengths. That is, the colored layer 16 lying opposite area III of the filter layer 25 through which the transmission light beam 27c is transmitted allows red light to pass through. The colored layer 16 lying opposite area II of the filter layer 25 through which the transmission light beam 27b is transmitted allows green light to pass through. The colored layer 16 lying opposite area I of the filter layer 25 through which the transmission light beam 27a is transmitted allows blue light to pass through.

A polarizer (not shown) is provided on the outer surface of each of the array substrate 22 and the counter substrate 17.

The prismatic sheet 30 and an optical control film (not shown) are provided between the backlight unit 20 and the glass substrate 1.

The backlight unit 20 includes a light source (not shown) such as a cold-cathode tube or LED and a high-reflectance inner surface covering the light source, and emits light fed from the light source to the liquid crystal panel 29. Before reaching the liquid crystal panel 29, the light passes through optical films such as the optical control film and the polarizer and enters the array substrate 22. Light in a wavelength range selected depending on the optical film thickness of the filter layer 25 at a corresponding position passes through the liquid crystal layer 13.

Most of the light having failed to be selected in the filter layer 25 is reflected and fed back toward the backlight unit 20. This recycled light 24 having reached the backlight unit 20 is reflected toward the liquid crystal panel 29 again by the high-reflectance inner surface substantially without an optical loss. At least 90% of the light having returned to the backlight unit 20 is recycled and then enters the liquid crystal panel 29 again.

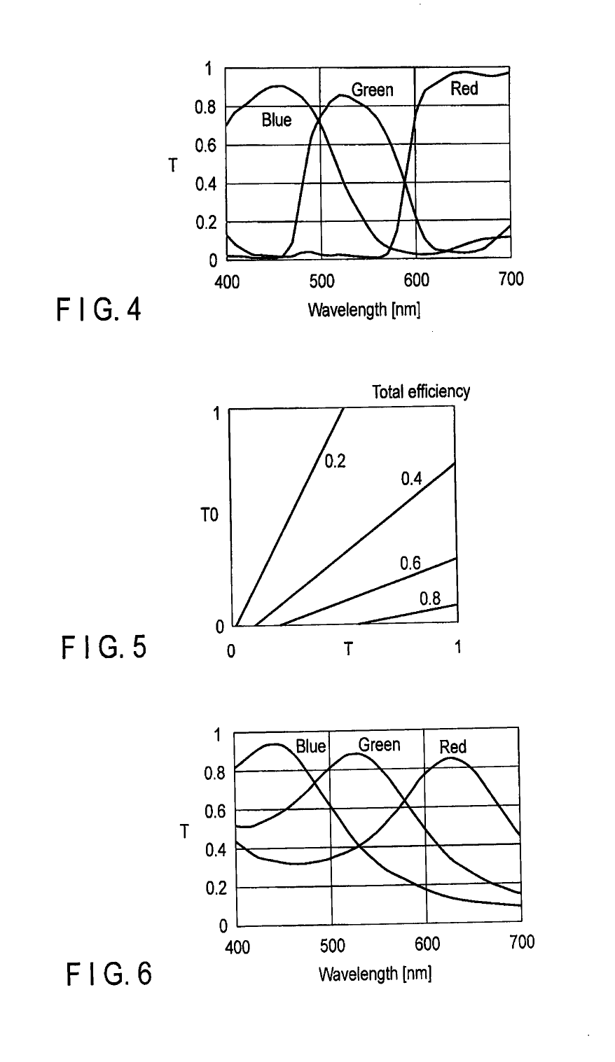

The light passing through the liquid crystal layer 13 then passes through the colored layer 16. The light transmission characteristics of the colored layer 16 for red, green, and blue are shown in FIG. 4. In FIG. 4, the ordinate T represents transmittance. Spectra of the respective colors overlap in an area with a low transmittance. This is originally not preferable for color reproducibility.

However, the liquid crystal display device in FIG. 3 includes the filter layer 25 on a light incident surface side of the colored layer 16. Light passing through each colored layer 16 is preselected by the filter layer 25. Light traveling to the colored layer corresponding to an area with a low transmittance is cut by the filter layer 25. This improves the color reproducibility compared to the conventional device. Thus, even the use of colored layers with a color purity lower than that of the colored layers 16 illustrated in FIG. 4 allows a sufficient color purity to be obtained depending on a combination with the filter 25. As a result, the light use efficiency for the display device as a whole is improved.

Light passing through the colored layer 16 passes though the polarizer and optical control film provided on the outer surface of the counter substrate 17 and reaches an observer.

Here, if incident light obliquely enters the array substrate 22, the optical length in the filter layer 25 is greater than the film thickness of the filter layer 25. Thus, the difference in phase between light passing through the film and light reflected by the film in this case differs from that in the case where light perpendicularly enters the array substrate 22. That is, if light obliquely enters the array substrate, the transmission wavelength range of the light is in principle shifted toward shorter wavelengths, that is, toward the blue side, when transmitted through the filter layer 25. This corresponds to the fact that the color viewed when the liquid crystal panel 29 is obliquely observed is significantly different from that viewed when the liquid crystal panel 29 is observed from a direction perpendicular to the substrate 1. To solve this problem, the color filter is effectively provided on the counter substrate 17 as described above. Even if oblique light emitted from the array substrate is shifted toward the blue side, a possible eventual change in color can be sufficiently suppressed by allowing the color filter 26 to selectively transmit light in the desired wavelength range.

Moreover, the above-described problem is solved by improving the directionality of light emitting from the backlight unit 20 to reduce light components obliquely entering the filter layer 25 in the array substrate 22. In this case, the viewing angle of the liquid crystal panel 29 is disadvantageously reduced, but a light scattering material may be provided such that a sufficient viewing angle is obtained after light passes though the colored layer 16 in the counter substrate, for example, a diffuser may be stuck to a front surface of the liquid crystal display device.

The filter layer 25 needs not only to reproduce a wavelength range corresponding to each color, but also to efficiently transmit light in the corresponding wavelength range and to efficiently reflect light in the wavelength ranges other than the transmission wavelength range. If the filter layer is formed only of a transparent film as in the conventional device as described above, almost no optical loss occurs in the filter layer. However, if the reflective layer is formed only of a transparent film, a large number of thin-films with different refractive indices are generally stacked to increase the reflectance, thus requiring many steps.

On the other hand, if the first reflective layer 2 and the second reflective layer 3 are formed of thin metal, a high reflectance can be easily achieved. The first reflective layer 2 and the second reflective layer 3 are preferably formed of silver, which exhibits excellent optical characteristics, that is, achieves a high reflectance and a reduced optical loss, particularly in the visible wavelength range. However, a metal layer absorbs light and thus a slight optical loss occurs. That is, the metal may not provide the filter layer 25 with both high transmissive and reflective performance and may consequently fail to achieve a sufficient optical recycle.

Thus, a recycling mechanism for light using the backlight unit 2 is examined in detail, and a guideline for solving the above-described problem is established. FIG. 5 shows the relationship between transmittance T for the transmission wavelength range and transmittance TO for the wavelength ranges other than the transmission wavelength range for a light use efficiency of 0.2, 0.4, 0.6, and 0.8. For example, to achieve a light use efficiency of 0.8, the allowable range of the transmittance of the filter layer 25 for the transmission wavelength range is set to between 0.5 and 1, whereas the allowable range of the transmittance for the wavelength ranges other than the transmission wavelength range is set to between 0 and 0.1. The increased transmittance of the filter layer 25 for the transmission wavelength range reduces the loss of light in the transmission wavelength range, thus correspondingly increasing the efficiency. In this case, however, the transmittance of light in the wavelength ranges other than the transmission wavelength range is also increased, leading to an increased number of optical components absorbed by the color filter 26 after passage through the filter layer 25. In contrast, the reduced transmittance of the filter layer 25 for the transmission wavelength range reduces the transmittance of light in the transmission wavelength range, but for light in the wavelength ranges other than the transmission wavelength range, increases the ratio of light reflected toward the backlight by the filter layer. This increases the efficiency of recycling and thus the light use efficiency of the liquid crystal panel as a whole. That is, increased light use efficiency can be achieved by reducing the transmittance, that is, improving the reflectance, in the wavelength ranges other than the transmission wavelength range, rather than increasing the transmittance of the filter layer 25.

This may be because the light transmitted through the filter layer 25 is about one-third of the total light, with the remaining light recycled, resulting in a significant recycling efficiency. In FIG. 5, to eventually increase the light use efficiency, for example, to achieve a light use efficiency of about 60%, the reflectance of the filter layer 25 for the wavelengths other than the transmission may be set to 80%, that is, the transmittance for the wavelength ranges other than the transmission wavelength range may be set to at most 20%.

The eventual light use efficiency of the filter layer 25 with the characteristics shown in FIG. 2 is determined. Then, the transmittance of light in the wavelength ranges other than the transmission wavelength range is lower than 20%, and the light use efficiency is 1.9 times as high as that obtained in the case where the filter layer 25 is not used.

For comparison, FIG. 6 shows an example of characteristics obtained when the optical transmittance for the wavelength ranges other than the transmission wavelength range is set to higher than 20%. The ordinate in FIG. 6 represents the transmittance. The thickness of an Ag reflective layer used as the filter layer 25 is set to a small value of 15 nm. Hence, the transmittance for the transmission wavelength range is higher than that shown in FIG. 2 but the transmittance for the wavelength ranges other than the transmission wavelength range is also increased, thus reducing the recycling efficiency. The eventual light use efficiency of the liquid crystal display device is determined in which the above-described settings are used for the filter layer 25. Then, the light use efficiency is 1.3 times as high as that obtained when the filer layer 25 is not used.

This indicates that even with the use of the filter layer configured to absorb light, sufficient light recycling can be achieved by reducing the optical transmittance for the wavelength ranges other than the transmission wavelength range, preferably to at most 20%.

The present embodiment includes the undercoat layer 7 but allows for a structure that avoids the provision of the undercoat layer 7.

Furthermore, the present embodiment includes one layer of the prismatic sheet 30 but may include a plurality of layers.

Specific embodiments will be described below.

### First Embodiment

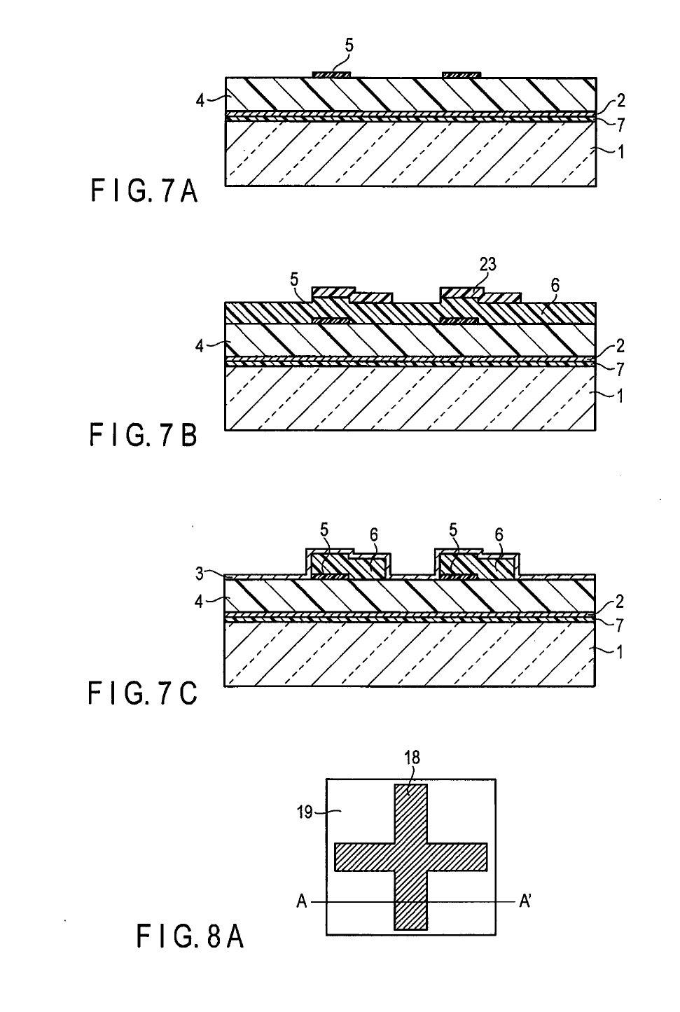

FIGS. 7A to 7C show a method for manufacturing a substrate with an interference filter according to a first embodiment.

As shown in FIG. 7A, a silicon dioxide film is formed, by chemical vacuum deposition (CVD), on the glass substrate 1 to a thickness of 100 nm as the undercoat layer 7. Subsequently, Ag is formed, by vacuum deposition, all over the surface of the undercoat layer 7 to a thickness of 25 nm as the first reflective layer 2. Subsequently, a silicon dioxide film is formed, by CVD, on the first reflective layer 2 to a thickness of 100 nm as the first spacer layer 4. Moreover, a silicon nitride film is formed, by CVD, on the first spacer layer 4 to a thickness of 25 nm as the second spacer layer 5. Then, a photosensitive resist layer 23 is patterned on the second spacer 5, and the second spacer layer 5 is etched using chemical dry etching, to remove the resist layer 23.

For the etching, if etching conditions for the chemical dry etching are such that the selectivity between the silicon nitride film to the silicon dioxide film is sufficiently high, that is, an etching rate for the silicon dioxide film is sufficiently low compared to that for the silicon nitride film, then during the dry etching, the silicon nitride film can be exclusively etched, suppressing etching damage done to the silicon dioxide film serving as an under layer. Conditions are successfully set such that the etching rate for the second spacer layer 5 is about 20 times as high as that for the first spacer layer 4. Thus, the etching damage done to the first spacer layer 4 is negligible.

Subsequently, as shown in FIG. 7B, a silicon nitride film is formed, by CVD, to a thickness of 15 nm as the third spacer layer 6. Moreover, the photosensitive resist layer 23 is formed so as to selectively cover the area in which the second spacer layer 5 and the third spacer layer 6 overlap each other and the area including the third spacer layer 6. The resist layer 23 is accurately aligned with reference to an alignment mark previously provided in an area different from the display area when the second spacer layer 5 is formed. Subsequently, the above-described chemical dry etching is used to etch away the first spacer layer 5 and the third spacer layer 6, and then the resist layer 23 is removed.

Subsequently, as shown in FIG. 7C, Ag is formed, by vacuum deposition, all over the surfaces of the third spacer layer 6 and the first spacer layer 4 to a thickness of 25 nm as the second reflective layer 3. Moreover, a silicon dioxide film is formed, by CVD, on the second reflective layer 3 to a thickness of 100 nm as the overcoat layer 8.

The above-described two spacer layer patterning steps allowed the Fabry-Perot-type filter layer 25 with three types of optical film thicknesses to be formed.

Then, a line group including the thin-film transistor 11, the pixel electrodes 9, and the signal lines 12 is formed on the filter layer 25. The structure of the line group is as shown in FIG. 1, and a specific method for manufacturing the line group is generally known and will thus not be described in detail. The gate line 10 is formed on the overcoat layer 8, and then the gate insulating film 28 is formed. Moreover, the thin-film transistor 11 is formed. A transparent conductive film is used to form the pixel electrodes 9, and then the signal lines 12 are formed to complete the thin-film transistor 11. The thin-film transistor 11 and the pixel electrodes 9 are also electrically connected.

The filter layer 25 needs to be accurately aligned with the pixel electrodes 9, the thin-film transistor 11, and the like need. The alignment can be easily achieved using the alignment mark 18 preformed during the formation of the filter layer 25.

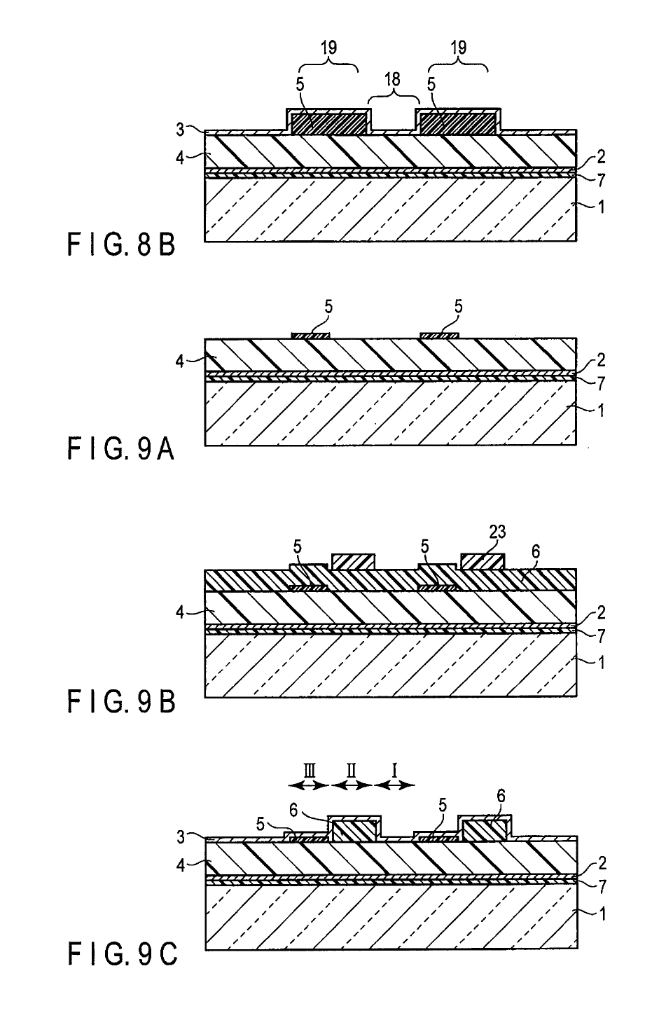

FIG. 8A is a plan view of the alignment mark 18. FIG. 8B is an enlarged view showing a cross section taken along line A-A′ in FIG. 8A.

A sufficient alignment mark has a structure pre-provided on the filter layer 25 and which exhibits a high reflectance when detected by an exposure device. The exposure device often uses green light to detect the alignment mark. In the present embodiment, a filter for the colors other than green which strongly reflect green light are arranged on the alignment mark 18 shown in FIG. 8B, and a filter that allows green light to pass through is arranged in a background 19 of the alignment mark. In this manner, the alignment mark with high contrast is successfully formed easily.

The color filter 26 is placed opposite the completed array substrate 22. The color filter 26 is provided on the counter substrate 17. The color filter 26 includes the colored layers 16, which are arranged opposite the respective pixels, and black matrices 14. The counterelectrode 15 is provided on the color filter 26. The liquid crystal layer 13 is arranged between the array substrate 22 and the color filter 26 to control the polarization state of the liquid crystal.

The prismatic sheet 30 is interposed between the backlight 20 and the liquid crystal panel 29 to improve the directionality of light exiting the back light unit 20. This further enhances the directionality. The enhanced directionality significantly suppresses a color shift on light obliquely entering the filter layer 25 included in the liquid crystal panel 29. However, when an observer views the screen, screen intensity may depend markedly on the viewing angle. Thus, when a light scattering film with a low degree of scattering is arranged on a side of the counter substrate 17 which is closer to the observer, the viewing angle dependence problem is solved.

As described above, the Fabry-Perot-type filter with three types of optical film thicknesses can be manufactured using a reduced number of steps. As a result, a liquid crystal display with high light use efficiency can be obtained.

### Second Embodiment

A second embodiment is different from the first embodiment in the arrangement for the first spacer, second spacer, and third spacer forming the filter layer. The same elements as those in the first embodiment are denoted by the same reference numerals and will not be described below.

FIGS. 9A, 9B, and 9C show another example of a substrate with the filter layer and a method for manufacturing the substrate according to the second embodiment.

The manufactured substrate with the filter layer according to the second embodiment is different from that according to the first embodiment in the structure of the filter layer 25 as shown in FIG. 9C. That is, in the filter layer 25 according to the second embodiment, the second spacer layer 5 is provided on a part of the first spacer layer 4. Furthermore, the third spacer layer 6 is provided on the first spacer layer 4 in a part of the area in which the second spacer layer 5 is not provided. Thus, the filter layer 25 includes an area I with the first spacer layer 4, an area II with the first spacer layer 4 and the third spacer layer 6, and an area III with the first spacer layer 4 and the second spacer layer 5.

As shown in FIG. 9A, a silicon dioxide film is formed, by CVD, on the glass substrate 1 to a thickness of 100 nm as the undercoat layer 7. Subsequently, Ag is formed, by vacuum deposition, all over the surface of the undercoat layer 7 to a thickness of 25 nm as the first reflective layer 2. Subsequently, a silicon dioxide film is formed, by CVD, on the first reflective layer 2 to a thickness of 100 nm as the first spacer layer 4. Moreover, a silicon nitride film is formed, by CVD, on the first spacer layer 4 to a thickness of 15 nm as the second spacer layer 5. Then, a photosensitive resist layer 23 is patterned, and the second spacer layer 5 is etched using chemical dry etching, to remove the resist layer 23. Conditions are successfully set such that the etching rate for the second spacer layer 5 is about 20 times as high as that for the first spacer layer 4. Thus, etching damage done to the first spacer layer 4 is negligible.

Subsequently, as shown in FIG. 9B, a silicon nitride film is formed, by CVD, to a thickness of 40 nm as the third spacer layer 6. In this case, a deposition temperature for the third spacer layer 6 is set lower than that for the second spacer layer. Specifically, the deposition temperature is 230° C. for the second spacer layer 5 and 170° C. for the third spacer layer. Moreover, the photosensitive resist layer 23 is formed so as to selectively cover the area with the third spacer layer 6. The resist layer 23 is accurately aligned with reference to an alignment mark previously provided in an area different from the display area when the second spacer layer 5 is formed. Subsequently, buffered hydrofluoric acid (BHF) is used to etch away the above-described third spacer layer 6, and then the resist layer 23 is removed. The second spacer layer and the third spacer layer can be separately formed as described above provided that the appropriate etch selectivity can be ensured between the second spacer layer 5 and the third spacer layer 6.

Subsequently, as shown in FIG. 9C, Ag is formed, by vacuum deposition, all over the surface of the resulting structure to a thickness of 25 nm as the second reflective layer 3. Moreover, a silicon dioxide film is formed, by CVD, on the second reflective layer 3 to a thickness of 100 nm as the overcoat layer 8.

The above-described two spacer layer patterning steps allow the Fabry-Perot-type filter layer 25 with three types of optical film thicknesses to be formed.

As described above, the second embodiment also allows the substrate 25 with the filter layer having three types of optical film thicknesses to be manufactured using a reduced number of steps. The use of the substrate 25 with the filter layer enables a liquid crystal display with high light use efficiency to be obtained.

### Third Embodiment

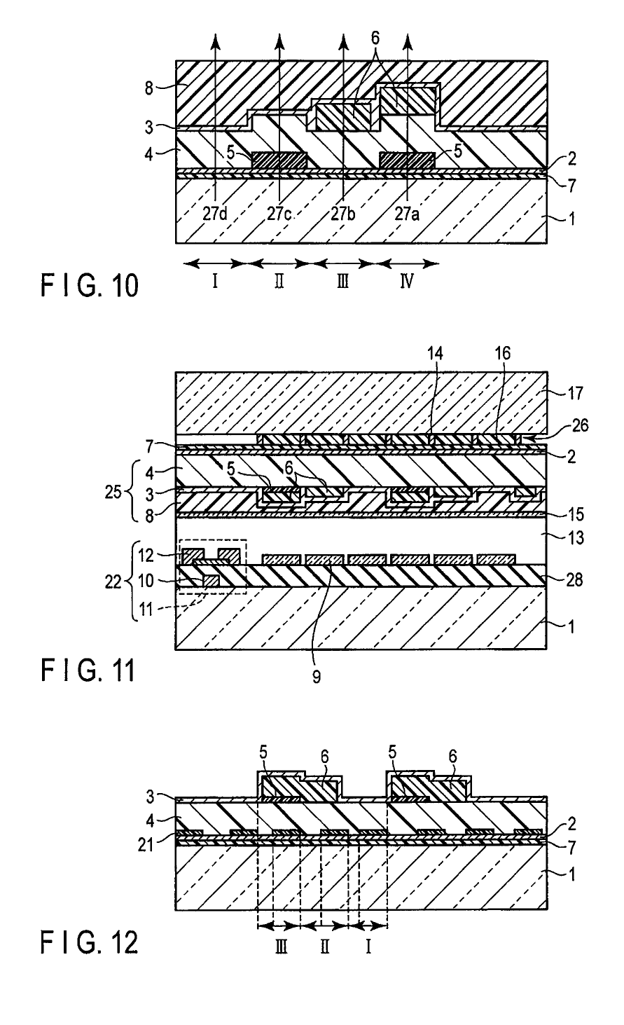

Moreover, such a configuration as shown in FIG. 10 can be provided. That is, the second spacer layer 5 is provided on at least two parts of the first reflective layer 2. The first spacer layer 4 is provided on the second spacer layer 5 and the first reflective layer 2. The third spacer layer 6 is provided on a part of the first spacer layer 4 which is provided on the spacer layer 5 provided on one of the two parts.

Furthermore, the third spacer layer 6 is provided on the first spacer layer 4 in a part of the area in which the second spacer layer 5 is not provided.

Thus, the filter layer 25 according to the present embodiment includes the following four areas. That is, the filter layer 25 includes, as the light-transmitting layer, an area I with the first spacer layer 4, an area II with the first spacer layer 4 provided on the second spacer layer 5, an area III with the third spacer layer 6 provided on the first spacer layer 4, and an area IV with the second spacer layer 5, the first spacer layer 4, and the third spacer layer 6 provided therein. In the configuration shown in FIG. 10, four types of optical film thicknesses corresponding to optical paths 27a, 27b, 27c, and 27d are formed in the respective areas. Two patterning operations enable the formation of a substrate with a filter layer which allows light in four colors to pass through.

### Fourth Embodiment

A fourth embodiment is different from the first embodiment in that the filter layer 25 is arranged on a front surface (on which light is incident) of the color filter 26 on the counter substrate 17. The same elements as those in the first embodiment are denoted by the same reference numerals and will not be described below.

FIG. 11 shows an example for the structure of a color filter according to the fourth embodiment. The color filter 26 is formed on the counter substrate 17, and includes the black matrices 14 and the colored layers 16 corresponding to the colors of the pixels. An acrylic resin of thickness 1 micron is provided, as the undercoat layer 7, on the color filter 26. Furthermore, as is the case with the first embodiment, in the filter layer 25, Ag is formed, by CVD, to a thickness of 25 nm as the first reflective layer 2 on the undercoat layer 7. Moreover, a silicon dioxide film is formed, by CVD, on the first reflective layer 2 to a thickness of 100 nm as the first spacer layer 4. Moreover, a silicon nitride film of thickness 25 nm is selectively formed on the first spacer layer 4 at positions corresponding to the pixels, as the second spacer layer 5.

A silicon nitride film of thickness 15 nm is selectively formed, as the third spacer layer 6, in an area in which the first spacer layer 4 and the second spacer layer 5 overlap each other and an area with the first spacer layer 4. Ag is deposited, as the second reflective layer 3, all over the surfaces of the first spacer layer 4, the second spacer layer 5, and the third spacer layer 6 to a thickness of 25 nm. A silicon dioxide film is further deposited on the second reflective layer 3 to a thickness of 100 nm as the overcoat layer 8. Indium tin oxide (ITO) alloy serving as a transparent electrode is deposited on the overcoat layer 8 to a thickness of 100 nm as a counterelectrode.

The counter substrate 17 including the color filter 26 and the filter layer 25 as described above is laminated to the separately produced array substrate 22 (not including the filter layer 25) to form the liquid crystal panel 29. In the array substrate 22, the gate insulating film 28, pixel electrodes 9, and thin-film transistor 11 are formed on the substrate 1.

The array substrate 22 is generally produced at a high process temperature, and thus the pre-produced filter layer 25 needs to resist high temperatures. However, a process for manufacturing the counter substrate 17 involves a relatively low temperature, and thus if the filter layer 25 is used for the counter substrate 17, a material that is sensitive to high temperatures can be used as the filter layer 25. The filter layer 25 can be differently configured as long as the filter layer 25 is located between the backlight 25 and the color filter 26.

The fourth embodiment also enables a Fabry-Perot-type filter with three types of optical film thicknesses to be manufactured using a reduced number of steps. This allows a liquid crystal display with high light use efficiency to be obtained.

### Fifth Embodiment

A fifth embodiment is different from the first embodiment in that minute uneven portions are provided between the first reflective layer 2 and the first spacer layer 3. The same elements as those in the first embodiment are denoted by the same reference numerals and will not be described below.

FIG. 12 shows another example of a substrate with an interference filter layer according to the fifth embodiment.

As shown in FIG. 12, a silicon dioxide film of thickness 100 nm is deposited, as the undercoat layer 7, on the glass substrate 1. Ag of thickness 25 nm is deposited, as the first reflective layer 2, all over the surface of the substrate 1.

Minute uneven portions 21 are formed on the first reflective layer 3. The sizes of the uneven portions 21 are such that the uneven portions 21 can be formed by a normal photolithography step, but are less than the pixel size (or the size of the colored layer). A silicon dioxide film of thickness 100 nm is deposited, as the first spacer layer 4, on the uneven portions 21 and the first reflective layer 2.

The second spacer layer 5 is selectively formed on the first spacer layer 4 using a silicon nitride film of thickness 25 nm. A silicon nitride film of thickness 15 nm is selectively formed, as the third spacer layer 6, in an area in which the first spacer layer 4 and the second spacer layer 5 overlap each other and an area only with the first spacer layer 4. Ag of thickness 25 nm is deposited, as the second reflective layer 3, all over the surfaces of the first spacer layer 4, the second spacer layer 5, and the third spacer layer 6. Moreover, a silicon dioxide film of thickness 100 nm is deposited, as the overcoat layer 8, on the second reflective layer 3.

The substrate 22 with the filter layer according to the present embodiment be formed by adding a step of forming the uneven portions 21 on the first reflective layer 4, to the first embodiment, and can be formed by three patterning steps. Moreover, each filter layer 25 includes areas with three different types of optical film thicknesses, and each area includes two types of small areas, that is, the portion in which the uneven portion is present and the portion in which the uneven portion is not present. The small areas involve slightly different transmission wavelength ranges, thus enabling an increase in the bandwidth covered by the transmission characteristics of the filter layer. Furthermore, providing the uneven portions with regularity enables the effect of an optical diffraction phenomenon to be exerted.

Increased bandwidth of light transmitted through the filter layer 25 allows a sufficient transmittance to be maintained even if the transmission wavelength range for light obliquely entering the filter shifts to the blue side. This is advantageous for the viewing angle of the liquid crystal display device.

The fifth embodiment also enables a Fabry-Perot-type filter with three types of optical film thicknesses to be manufactured using a reduced number of steps. This allows a liquid crystal display with high light use efficiency to be obtained.

According to at least one of embodiments described above, there are provided a substrate with an interference filter layer which can be formed by a reduced number of steps and which allows light to be efficiently used, and a display device using the substrate with the interference filter layer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A substrate with an interference filter layer, the substrate comprising:
a plate-like first substrate; and
a filter layer comprising a first reflective layer provided on the first substrate, a light-transmitting layer provided on the first reflective layer, and a second reflective layer provided on the light-transmitting layer, the first reflective layer and the second reflective layer being optically semi-transparent, the light-transmitting layer being formed of a first spacer layer provided on the first reflective layer, a second spacer layer, and a third spacer layer, the second spacer layer and the third spacer layer being provided on or above parts of the first reflective layer, the first spacer layer, the second spacer layer, and the third spacer layer being optically transparent, the light-transmitting layer comprising a first area, a second area, and a third area which comprise the first spacer layer in common, the first area, the second area, and the third area having different optical film thicknesses due to the second spacer layer and the third spacer layer, the first area, the second area, and the third area transmitting light with different wavelengths.

2. The substrate according to claim 1, wherein
the first spacer layer is provided on the first reflective layer,
the second spacer layer is provided on a first part of the first spacer layer, and
the third spacer layer is provided on the second spacer layer and on a second part of the first spacer layer, the second part being different from the first part.

3. The substrate according to claim 1, wherein
the first spacer layer is provided on the first reflective layer,
the second spacer layer is provided on a first part of the first spacer layer, and
the third spacer layer is provided on a second part of the first spacer layer, the second part being different from the first part.

4. A display device comprising:
a plate-like first substrate comprising a first principal surface;
a filter layer comprising a first reflective layer provided on the first principal surface, a light-transmitting layer provided on the first reflective layer, and a second reflective layer provided on the light-transmitting layer, the first reflective layer and the second reflective layer being optically semi-transparent, the light-transmitting layer being formed of a first spacer layer provided on the first reflective layer, a second spacer layer, and a third spacer layer, the second spacer layer and the third spacer layer being provided on or above parts of the first reflective layer, the first spacer layer, the second spacer layer, and the third spacer layer being optically transparent, the light-transmitting layer comprising a first area, a second area, and a third area which comprise the first spacer layer in common, the first area, the second area, and the third area having different optical film thicknesses due to the second spacer layer and the third spacer layer, the first area, the second area, and the third area transmitting light with different wavelengths;
a plate-like second substrate comprising a second principal surface arranged opposite the first principal surface; and
an optical modulation layer arranged between the first principal surface and the second principal surface.

5. The device according to claim 4, wherein the second substrate comprises colored layers provided opposite the first area, the second area, and the third area, each of the colored layers transmitting a part of light which passes through a corresponding area of the first area, the second area, and the third area.

6. The device according to claim 4, wherein
the first spacer layer is provided on the first reflective layer,
the second spacer layer is provided on a first part of the first spacer layer, and
the third spacer layer is provided on the second spacer layer and on a second part of the first spacer layer, the second part being different from the first part.

7. The device according to claim 4, wherein
the first spacer layer is provided on the first reflective layer,
the second spacer layer is provided on a first part of the first spacer layer, and
the third spacer layer is provided on a second part of the first spacer layer, the second part being different from the first part.

8. The device according to claim 4, wherein
the light-transmitting layer further comprises a fourth area different from the first area, the second area, and the third area in optical film thickness,
the second spacer layer is provided on two parts of the first reflection layer,
the first spacer layer is provided on the second spacer layer and on the first reflective layer, and
the third spacer layer is provided on a part of the first spacer layer within a range where the second spacer is not provided and on the first spacer layer provided on one of the two parts.

9. The device according to claim 4, wherein the first reflective layer and the second reflective layer are made of metal.

10. A display device comprising:
a plate-like first substrate;
a plate-like second substrate comprising a principal surface arranged opposite the first substrate;
three or more colored layers provided on one principal surface of the second substrate and each transmitting light with different wavelengths;
a filter layer comprising a first reflective layer provided on the colored layers, a light-transmitting layer provided on the first reflective layer, and a second reflective layer provided on the light-transmitting layer, the first reflective layer and the second reflective layer being optically semi-transparent, the light-transmitting layer being formed of a first spacer layer provided on the first reflective layer, a second spacer layer, and a third spacer layer, the second spacer layer and the third spacer layer being provided on or above parts of the first reflective layer, the first spacer layer, the second spacer layer, and the third spacer layer being optically transparent, the light-transmitting layer comprising a first area, a second area, and a third area which comprise the first spacer layer in common, the first area, the second area, and the third area having different optical film thicknesses due to the second spacer layer and the third spacer layer, the first area, the second area, and the third area transmitting light with different wavelengths; and
an optical modulation layer arranged between the first substrate and the second substrate, wherein each of the colored layers transmits a part of light which passes through an area of the filter layer, the area being arranged opposite the colored layer.
